(19) United States
(12) Patent Application Publication
(10) Pub. No.: US 2016/0267234 A1
(43) Pub. Date: Sep. 15, 2016

(54) JOINT SURGERY TRIAGE TOOL

(71) Applicant: T. Derek V. Cooke, Perth (CA)

(72) Inventor: T. Derek V. Cooke, Perth (CA)

(21) Appl. No.: 14/725,533

(22) Filed: May 29, 2015

(30) Foreign Application Priority Data
May 30, 2014 (CA) 2853012

(51) Int. Cl. G06F 19/00; G06T 7/00; G06N 5/04

(52) U.S. Cl. CPC G06F 19/345; G06N 5/045; G06T 7/0012; G06T 2207/10124

(57) ABSTRACT

A computerized method provides remote access to orthopaedic triage services. A user accesses a computerized graphical interface having at least one of a first graphical interface for input of data including personal metrics, a second interface for input of answers to standardized functional impairment queries, and a third interface for input of prior surgery or injury queries. The user uploads a radiographic image file. One or more of the data categories are tabulated, weighted, and combined to define a computerized preliminary factor. The uploaded radiographic image is analyzed to obtain a standardized score corresponding to the severity of bone or joint damage shown on the image, the standardized score being weighted, and combined, by the computer with the preliminary factor to obtain a final score. The final score is compared by the computer with the scores obtained from evidence based clinical studies to obtain a ranking and ultimate reporting.

### BACKGROUND

The therapeutic decision making process to replace an Osteoarthritic (OA) joint with an implant, Total Joint Replacement (TJR), is varied and plagued with uncertainties. There is uncertainty as to the optimal timing for TJR and no accepted criteria exist as to the appropriateness for referral by the General Practitioner (GP) or even for the decision made by the Orthopaedic Surgeon (OS). As a result, there are uncertainties and delays in referrals and in the level of care provided and considerable variation in outcome. Poor outcomes, requiring revision surgery or continuing care, add greatly to costs. Thus, the impact of these problems has huge economic implications which increase with the needs of our aging population. Furthermore, the knowledge of OA is generally limited to expert clinicians working in the musculoskeletal field. General understanding of OA, while acknowledged as being incurable, lacks the education and means for early diagnosis and importance of instituting preventative measures that may materially maintain function and delay needs for surgery. This lack of knowledge about the OA and it natural history is widespread amongst GPs and patients, which adds to these problems.

Current Referral Process comprises the steps of 1. Direct referral of an OA patient by the GP usually by means of a faxed letter to the OS, or 2. Indirect referral by the GP to a Triage Clinic and then on to the OS.

Both processes suffer from uncertainties. The faxed referral from the GP varies in content of relevant clinical and radiographic information. There are major variations in timely consultation. There are distance and travel logistical difficulties. The recommendation by the OS for surgery varies from 50 to 80%. On the other hand, Clinics vary greatly in distribution, frequently impose travel difficulties, and add a second step to the process. They are staffed by Advance Practice Therapists, trained by surgeons, without use of evidence based criteria for the patient triage. The clinics add costs for the facility and the staff needed to run them.

Currently, a Surgical Decision is largely based on clinical experience of the OS using skills for clinical and radiographic evaluation developed during their training. However, major variations in TJR patterns are evident in Canada and in the US. Of great relevance, the surgical decision lacks use of evidence based criteria as to the severity of the arthritic process or the extent of patient limitations.

The general public has limited understanding of OA process. Many, with joint pain, and X-ray evidence of OA, demand an MRI of the joint in the mistaken belief that advanced imaging will offer improved solutions.

Non-surgical therapy often uses selections of pain and anti-inflammatory medications and cartilage based joint supplements, none having any basis for improvement, but many, with potential added side effects.

### SUMMARY

The objective of the present invention is to improve the therapeutic decision making process for OA joint care and the general knowledge of OA by use of evidenced based criteria on the severity of the OA case in the form of ‘A Joint Surgery Triage (JST) Tool’. The JST tool includes evidence based Disability Assessment and Radiographic Grading. These, in combination with patient age and potentially other factors, are used to create a quantified measure of the Arthritic Severity. The JST of the present invention is a ‘Web Based Service’, readily available to both the referring and treating clinicians, as well as to the patient themselves, as an educational step or another opinion. The tool provides standardised quantified assessments of the arthritic severity, with guidance for timely and appropriate referral, improving the surgical decision making process, improving outcomes thereby lessening the ever rising costs of TJR.

In a broad aspect, the present invention provides a computer implemented method of providing remote access to orthopaedic triage services wherein a user is presented, via a computer, with a graphical interface comprising at least one or more of a first graphical interface for input of data comprising personal metrics, a second graphical interface for input of data comprising answers to standardized functional impairment queries, and a third graphical interface for input of prior surgery or injury queries; said user is prompted to upload a radiographic image file to said system; one or more of the personal metrics, functional impairment answers, and prior surgery answers are tabulated, weighted, and combined by a computer to define a preliminary factor; said radiographic image uploaded by said user is subjected to standard analysis to obtain a standardized radiographic score corresponding to the severity of bone or joint damage shown on said radiographic image; the standardized radiographic score being weighted, and combined, by said computer with the preliminary factor to obtain a final score, said final score being compared by said computer with the scores obtained from evidence based clinical studies to obtain a ranking, and the tabulated answers, standardized image analysis, and rankings are forwarded to a clinician or other user in the form of a triage report, whereby a triage decision can be made by a user on the basis of ranking, and available resources.

### BRIEF DESCRIPTION OF THE DRAWINGS

In drawings that illustrate the present invention by way of example.

FIGS. 1A-1F are examples of relevant portions of user interface.

FIG. 2 is an example of a report produced by the method of the present invention.

FIG. 3 is an example of a severity index calculator that may be used in the present invention.

### DETAILED DESCRIPTION

The following description provides a summary of information relevant to the present disclosure and is not an admission that any of the information provided or publications referenced herein is prior art to the present disclosure.

Reference will be made to representative embodiments of the invention. While the invention will be described in conjunction with the enumerated embodiments, it will be understood that the invention is not intended to be limited to those embodiments. On the contrary, the invention is intended to cover all alternatives, modifications, and equivalents that may be included within the scope of the present invention as defined by the claims.

One skilled in the art will recognize many methods and materials similar or equivalent to those described herein, which could be used in and are within the scope of the practice of the present invention. The present invention is in no way limited to the methods and materials described.

Unless defined otherwise, technical and scientific terms used herein have the same meaning as commonly understood by one of ordinary skill in the art to which this invention belongs. Although any methods, devices, and materials similar or equivalent to those described herein can be used in the practice or testing of the invention, the preferred methods, devices and materials are described. All publications, published patent documents, and patent applications cited in this application are indicative of the level of skill in the art(s) to which the application pertains. All publications, published patent documents, and patent applications cited herein are hereby incorporated by reference to the same extent as though each individual publication, published patent document, or patent application was specifically and individually indicated as being incorporated by reference.

As used in this application, including the appended claims, the singular forms “a,” “an,” and “the” include plural references, unless the content clearly dictates otherwise, and are used interchangeably with “at least one” and “one or more.”

As used herein, the term “about” represents an insignificant modification or variation of the numerical value such that the basic function of the item to which the numerical value relates is unchanged.

As used herein, the terms “comprises,” “comprising,” “includes,” “including,” “contains,” “containing,” and any variations thereof, are intended to cover a non-exclusive inclusion, such that a process, method, product-by-process, or composition of matter that comprises, includes, or contains an element or list of elements does not include only those elements but may include other elements not expressly listed or inherent to such process, method, product-by-process, or composition of matter.

In the present invention Evidenced Based Disability Assessments, such as Western Ontario McMaster Arthritis Criteria (WOMAC) (see Bellamy N WOMAC Osteoarthritis Index User Guide. Version V. Brisbane, Australia 2002) are used in combination with a validated, reliable Radiographic Grading, such as Compartmental Grading (CG) or Unicompartmental OA Grading (UCOAG) (see Cooke et al, Cooke T D V, Kelly B P, Harrison L, Mohamed G and Khan B: “Radiographic Grading for Knee Osteoarthritis: A revised scheme that relates to alignment and deformity. J Rheumatol 1999:26, 3: 641-644) together with select demographic and historical information (such as age, prior injury or surgery, and inflammatory joint disease), in a computerized web based tool to establish a basis to triage the needs for Joint Replacement Surgery or other appropriate care. In the context of Knee Evaluation, the present invention provides a web based means for an evidenced assessment of an individual's OA joint problem.

The OA Knee is used to exemplify the appropriate application of the present Triage “tool”. This is with the understanding that the tool may be suitably modified to triage the need for surgery of the hip, shoulder and other joints using appropriately developed assessments methods.

The web based method of the present invention uses specific radiographic and clinical features of Knee OA cases. A CG grading of 6 or more of 13 carries high correlation for the recommendation for surgery (odds ratio of 6 or more). A disability score (as defined by WOMAC of 45 or more of 100 also correlates strongly. The demographic of age greater than 60 years correlates positively as well with the surgical recommendation for TKR. Prior surgery on the joint in question also correlates strongly, at about the same level as an age greater than 60 years, with a surgical recommendation for TKR. The combination of these four features and ranking them against others in the system may be used to provide a reliable basis for a surgical recommendation. It will be understood, however, that additional considerations may apply.

### Disability Evaluations

WOMAC exemplifies one of many validated disability questionnaires that may be used for the assessment of Arthritic limitations. It has been successfully applied in assessments of knee and/or hip joint disability. It is completed as a patient self-administered tool, it is widely used and available in different languages. WOMAC is a composite of scores for Pain, various Functional and mobility limitations, each graded as 0 none to 5 extreme severity, for a Total Score of 0 no disability to 100 representing extreme limitations. Other disability evaluations may be of a more generalised approach such as the SF 36, or in its short form SF12. Others may be more focused to a joint condition include the Oxford Knee Score, The Knee Society score or, for the Hip, the Harris Hip Score. In our experience WOMAC is preferably applicable as a self-administered tool and has functioned as well as other scores and is our current selection. But, as the Triage process evolves, other disability evaluations, including both more general and or more joint specific scores may be applied with advantage.

In recent research at Queen's University the inventors applied a series of disability evaluations to some 180 case sent for knee surgery evaluation. They all had correlations for the independent surgical decision based on their odds ratios, but WOMAC scores, seen below in Table 1, were preferred.

TABLE 1

| | | | | | | 95% Confidence | |
|---|---|---|---|---|---|---|---|
| | | | | | | Interval for Mean | |
| | | | | Std. | Std. | Lower | Upper |
| | | N | Mean | Deviation | Error | Bound | Bound |
| WOMAC pain scored | Not appropriate | 46 | 5.59 | 3.01 | .44 | 4.69 | 6.48 |
| 0-20 | Appropriate but declined | 48 | 5.71 | 3.46 | .50 | 4.70 | 6.71 |
| | Appropriate and done or booked | 79 | 8.47 | 2.93 | .33 | 7.81 | 9.12 |
| | Total | 173 | 6.94 | 3.39 | .26 | 6.43 | 7.45 |
| WOMAC stiffness | Not appropriate | 46 | 3.33 | 1.79 | .26 | 2.79 | 3.86 |
| scored 0-8 | Appropriate but declined | 48 | 3.69 | 1.84 | .26 | 3.15 | 4.22 |
| | Appropriate and done or booked | 78 | 4.69 | 1.70 | .19 | 4.31 | 5.08 |
| | Total | 172 | 4.05 | 1.85 | .14 | 3.77 | 4.33 |
| WOMAC function | Not appropriate | 46 | 21.76 | 12.98 | 1.91 | 17.91 | 25.62 |
| scored 0-68 | Appropriate but declined | 48 | 22.96 | 15.16 | 2.19 | 18.56 | 27.36 |
| | Appropriate and done or booked | 78 | 37.21 | 11.08 | 1.25 | 34.71 | 39.70 |
| | Total | 172 | 29.10 | 14.76 | 1.13 | 26.88 | 31.32 |
| WOMAC out of 100 | Not appropriate | 46 | 31.95 | 17.56 | 2.59 | 26.74 | 37.17 |
| | Appropriate but declined | 48 | 33.70 | 20.53 | 2.96 | 27.74 | 39.66 |
| | Appropriate and done or booked | 77 | 52.77 | 14.90 | 1.70 | 49.39 | 56.16 |
| | Total | 171 | 41.82 | 19.92 | 1.52 | 38.81 | 44.83 |

### Radiographic Gradings

Compartmental evaluation, specifically the Compartmental OA Grading—(CG) applied to Knee radiographic, is a validated instrument. It incorporates composite assessments of Joint Space loss (graded 0-3), Osteophytic (new bone) formation (0-3), Tibial bone erosion (0-4), and Subluxation (0-3) for a Total Score providing a wide spectrum from 0, no radiographic changes, to 13, extreme damage. Importantly, it is applied to the most damaged compartment. The Total Score correlates strongly with Alignment of the knee as measured by the Hip-Knee-Ankle (HKA) angle. Other scoring mechanisms might be used, for instance, The Kellgren Lawrence OA grading. Recent research suggests greater utility, reliability and sensitivity in use of the UCOAG grading than other grading schemes see Sheehy et al Abstract OARSI (L Sheehy, T D V Cooke, J Lynch, M Nevitt, L McLean, J Niu, N A Segal, J Singh, E Culham ‘Reliability of a unicompartmental scale for the radiographic evaluation of knee osteoarthritis: Data from the Multicenter Osteoarthritis Study (MOST)’. Proceedings of OARSI conference September 2013 Baltimore). The choice of CG does not preclude the future use of a different grading scheme that might provide as good or better correlation with joint function and alignment.

A similar composite compartmental evaluation as the Tibio-femoral grading has been developed for the Patello-Femoral compartments of the knee by the applicant in which the most damaged medial or lateral part is graded for Joint Space 0-3, Femoral Osteophytres (0-3), Patella Erosion (0-3), Subluxation (0-3), for a Total Score range from 0-10. This scheme is an effective means to evaluate the Patello-femoral joint in addition to the TF joints of the knee.

Age is an important criterion for inclusion in the present JST tool. OA may progress with age. Surgery undertaken too early carries higher risks of poor outcomes and failure. Other factors such as past injury or prior surgery also correlate with a need for surgery at a lesser odds ratio.

In the same research study each presenting patient received a standing anteroposterior radiograph of the knee and a patella femoral skyline view. These were each correlated independently to the surgical recommendation using the CG scheme. Total score grades of 6 and above were matched with an appropriate recommendation for surgery as indexed by an elevated odds ratio. Table 2 summarizes this aspect of the study.

TABLE 2

| | | | | | | 95% Confidence | |
|---|---|---|---|---|---|---|---|
| | | | | | | Interval for Mean | |
| | | | | Std. | Std. | Lower | Upper |
| | | N | Mean | Deviation | Error | Bound | Bound |
| X-ray Joint space | Not appropriate | 46 | 1.33 | .56 | .08 | 1.16 | 1.49 |
| | Appropriate but declined | 48 | 2.08 | .65 | .09 | 1.90 | 2.27 |
| | Appropriate and done or booked | 78 | 2.45 | .68 | .08 | 2.30 | 2.60 |
| | Total | 172 | 2.05 | .79 | .06 | 1.93 | 2.16 |
| X-ray Osteophytes | Not appropriate | 46 | 1.33 | .63 | .09 | 1.14 | 1.51 |
| | Appropriate but declined | 48 | 1.60 | .64 | .09 | 1.42 | 1.79 |
| | Appropriate and done or booked | 78 | 2.22 | .77 | .09 | 2.05 | 2.39 |
| | Total | 172 | 1.81 | .80 | .06 | 1.69 | 1.93 |
| X-ray Tibial erosion | Not appropriate | 46 | .02 | .15 | .02 | −.02 | .07 |
| | Appropriate but declined | 48 | .33 | .63 | .09 | .15 | .52 |
| | Appropriate and done or booked | 78 | .85 | .94 | .11 | .63 | 1.06 |
| | Total | 172 | .48 | .80 | .06 | .36 | .60 |
| X-ray Subluxion | Not appropriate | 46 | 1.11 | .71 | .10 | .90 | 1.32 |
| | Appropriate but declined | 48 | .92 | .79 | .11 | .69 | 1.15 |
| | Appropriate and done or booked | 78 | .99 | .78 | .09 | .81 | 1.16 |
| | Total | 172 | 1.00 | .76 | .06 | .88 | 1.12 |
| X-ray total score | Not appropriate | 46 | 3.78 | 1.11 | .16 | 3.45 | 4.11 |
| | Appropriate but declined | 48 | 4.94 | 1.85 | .27 | 4.40 | 5.47 |
| | Appropriate and done or booked | 78 | 6.50 | 2.21 | .25 | 6.00 | 7.00 |
| | Total | 172 | 5.34 | 2.19 | .17 | 5.01 | 5.67 |

Previously, it was considered by the applicant that Disability evaluation (DE), WOMAC, and Compartmental Radiographic Grading (RG), UCOAG, may enable a composite indication of joint severity. In recent clinical studies, see Harrison M, Cooke T D, Hope J, Brean M, Hopman W: ‘Development of a novel triage tool for knee osteoarthritis. Proceeding of OARSI September 2013, Baltimore), these each provided substantially increased odds ratios of the surgical recommendation of TKR. However, other factors such as age joint injury or past surgery show significance and are considered factors in the present by the applicant has gathered demographic date for referred cases. Age was considered as divisions of 10. The appropriate cases for surgery were above 60 years as defined by their odds ratio. Table 3 illustrates this.

TABLE 3

| | | | | | | 95% Confidence | |
|---|---|---|---|---|---|---|---|
| | | | | | | Interval for Mean | |
| | | | | Std. | Std. | Lower | Upper |
| | | N | Mean | Deviation | Error | Bound | Bound |
| Age | Not appropriate | 46 | 61.00 | 10.33 | 1.52 | 57.93 | 64.07 |
| | Appropriate but declined | 48 | 65.02 | 8.68 | 1.25 | 62.50 | 67.54 |
| | Appropriate and done or booked | 79 | 67.97 | 10.80 | 1.21 | 65.56 | 70.39 |
| | Total | 173 | 65.30 | 10.47 | .80 | 63.73 | 66.87 |

KST severity is therefore based on the empirical consideration for interaction of these significant odds ratio positive factors. For instance, a case with DE of 50/100, TF RG 6/13, age of 60 provides a strong consideration for TKR. However, the example of DE of 20/100, TF RG of 6/13 age 60, while compatible for TKR (based on RG and Age) may reasonably wait until functional capacity declines. Care recommendations include maintaining a low weight, and knee strength exercise, with repeat of KST in a year or earlier if function declines. The example of DE 70/100, RG 7/13, Age 70 may deserve more urgent TKR consideration, since it is known that an advanced arthritic status, while improved by TKR, will have a lesser expectation for a high functional outcome. A case of DE 60, RG 4/13, age 50 treated with TKR carries increased long term risk for failure, a relative contraindication for TKR; but, this case may be suitable for alternative less radical surgery, such as corrective TF alignment, if other conservative approaches (Weight loss, activity modification, bracing) are unsuccessful.

In research leading up to the present invention, factors for age, DE, and RG were assigned equal weights, so that an aggregate score of 3, (lower levels for Age<60, DE 30, RG 4) would triage the case for Non-Surgical care. Moderate DE and RG, aged at 6 would be surgical considerations and 9 late/urgent cases. However, it has since been determined that age over 60 and prior surgery or injury should be assigned equal weight, DE about twice that weight, and RG about four times the weight of age or prior surgery.

Current weighting for the clinical factors shown to have evidenced based correlations for clinical decisions, such as surgery, are afforded equally. However, it is likely that the severity index may be improved by refining the use of the weightings for each factor. Thus, it is reasonable to indicate that DE will afford greater weight to the clinical decision as compared to age. Further, that RG will carry greater weight that DE. Some level of uncertainty is needed to allow for optimization of weights, and where it is unlikely that weightings of greater than a factor of 4 will be more advantageous to the clinical decision, the use of discriminative analysis and outcome modelling techniques may optimize weighting to be applied to each factor.

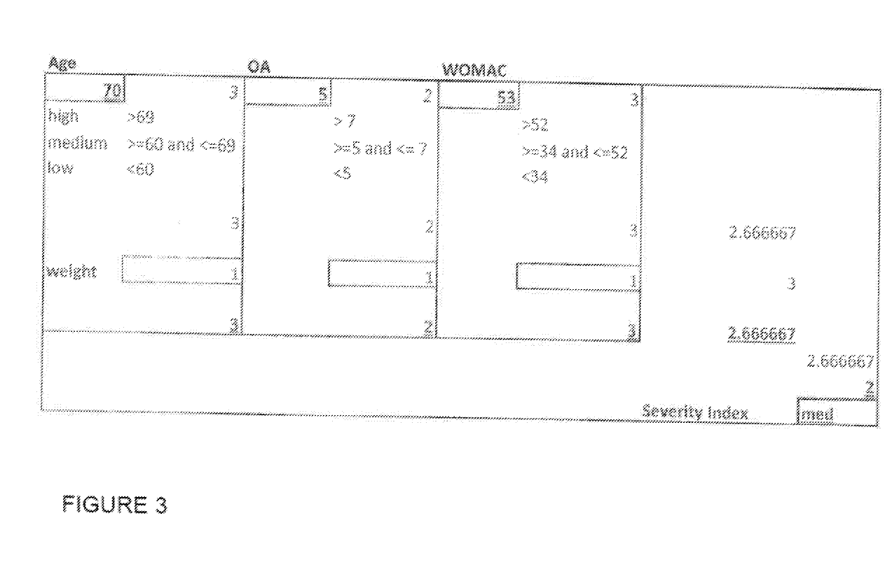

Moreover, the subjectivity of grading for KST may be substantially eliminated by the use of a Severity Index calculator according to the present invention. With reference to FIG. 3, each of a selected number of factors, three in the example shown, is weighted and possible scores for each factor are divided into ranges, with each range assigned a value.

In the example shown, age is divided into three ranges, >69, 60 to 69, and <60, with the values of 3, 2 and 1 assigned to each range.

Similarly, DE and prior surgery/injury scores are divided into ranges, and values assigned to each range. Each factor is weighted, in the example shown, with a weight of 1. The Severity Index will be the average value of the factors, considering the weighting.

It will be understood that selection of ranges and factor weight will be a matter of professional skill and judgement, and may to some extent be dependent on available medical resources and cost. Similarly, legal considerations may dictate that age ranges should be shifted to provide for a broader middle range.

Moreover, while a clinician or institution may consider radiographic grading to be the most important factor, use of a calculator like that shown in FIG. 3 should ensure that no decision is made using radiographic evidence alone.

Hip, Shoulder, Ankle Radiographic OA Gradings. It is to be anticipated that, based on teachings of the Knee CG evaluations, that similar composite approaches may be applied for other OA joint problems as identified above requiring surgical care in the form of a triage tool when shown to be reliable and sensitive.

While the KST tool has been shown to accurately and reliably evaluate Knee OA cases for severity of damage, false positives may occur in situations of pain being referred from hip or spine to the knee; but radiographic evaluation would in those instances be negative suggesting other issues. Cases with inflammatory arthritis may present with knee symptoms of swelling heat as well as painful motion; the radiographic changes are generalised, seldom well localized to a compartment. Such cases may be signalled by historical information of polyarthritis with inflammatory features. Injury may present with symptoms of internal derangement and knee pain. Radiographic evaluation may show fractures lacking features of OA. The inclusion of specify questions as to the history of a recent injury, features of joint derangement, polyarthritis and inflammatory joint symptoms, will improve the specificity of the KST to exclude other disease entities and help identify OA cases.

### Web Based Applications

The Joint Surgery Triage concept is developed to be applied as a web based Tool. Such an application requires the provision of a suitable web interface with appropriate portals for use dependant on the specifics identified. These may include portals for physicians, both referring and those treating OA Joint Cases (Orthopaedic Surgeons, Rheumatologist, Physiotherapists to identify common practitioners). In addition, the tool may be used by any individual to gain information about their own joint condition.

Thus, for a General Physician, the GP would use the tool to establish the Arthritic severity of a patient presenting with for example historical information of knee pain with an older demographic suggestive of Knee OA. The patient would complete the Disability Questionnaire and obtain a Standing Antero-posterior and a skyline Patello-femoral radiographic views of the knee.

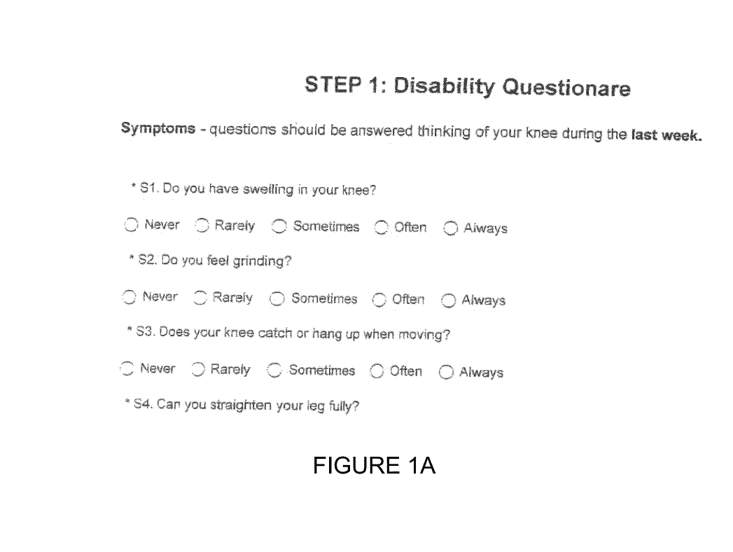

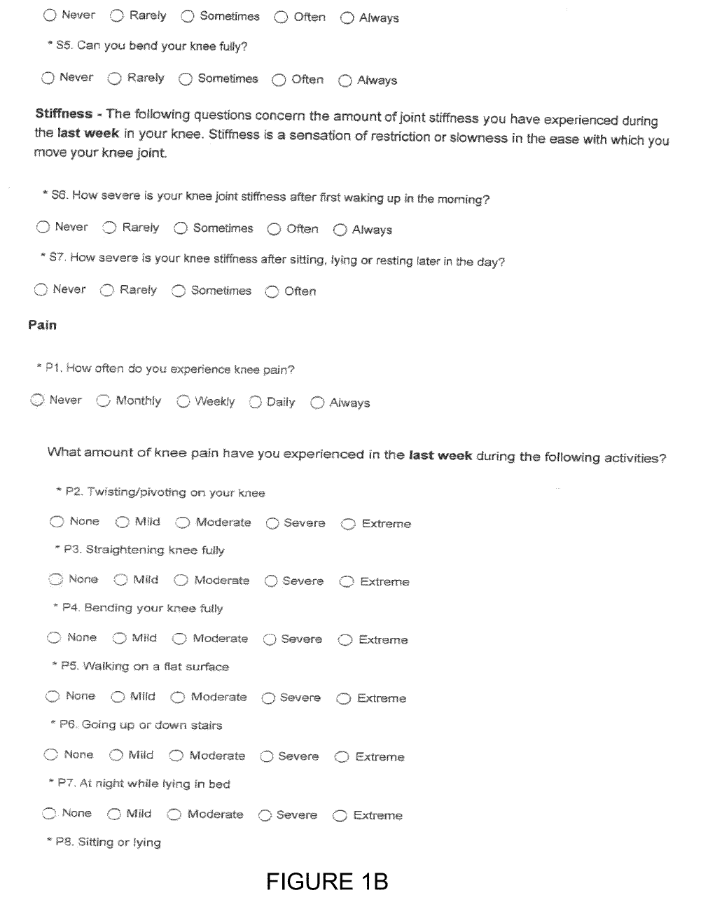

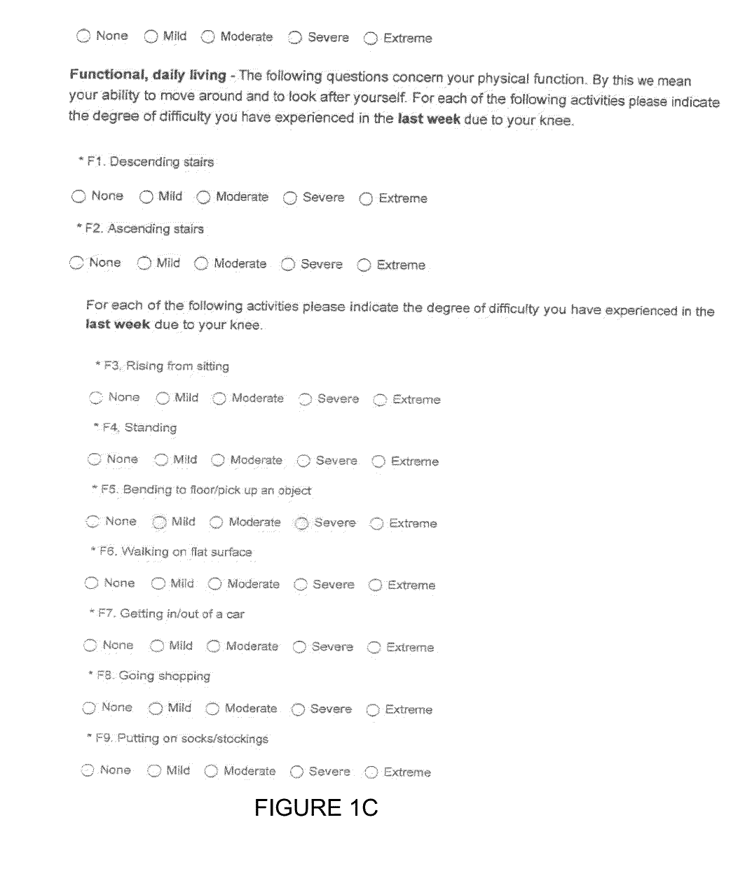

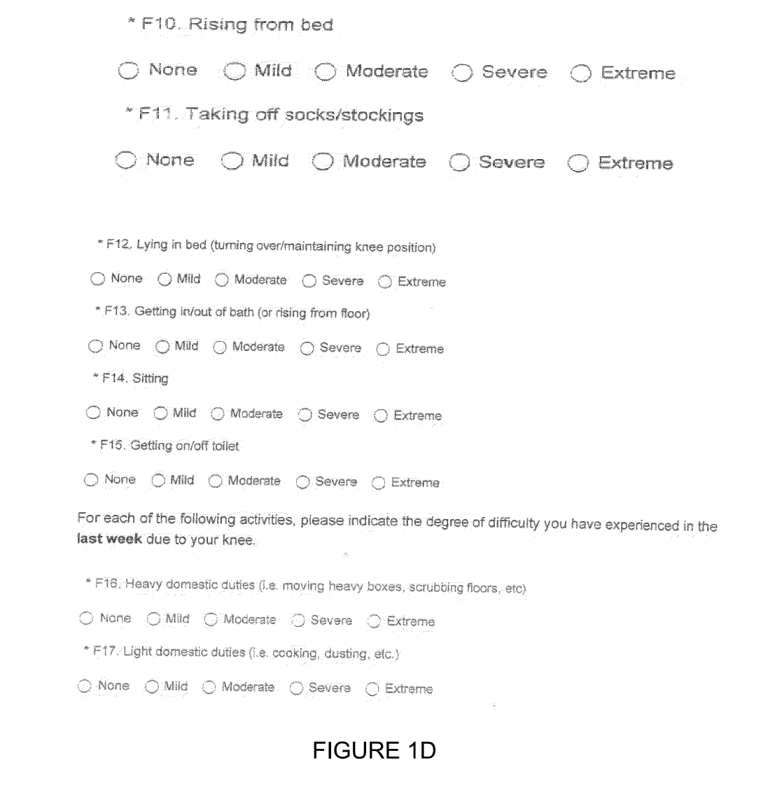

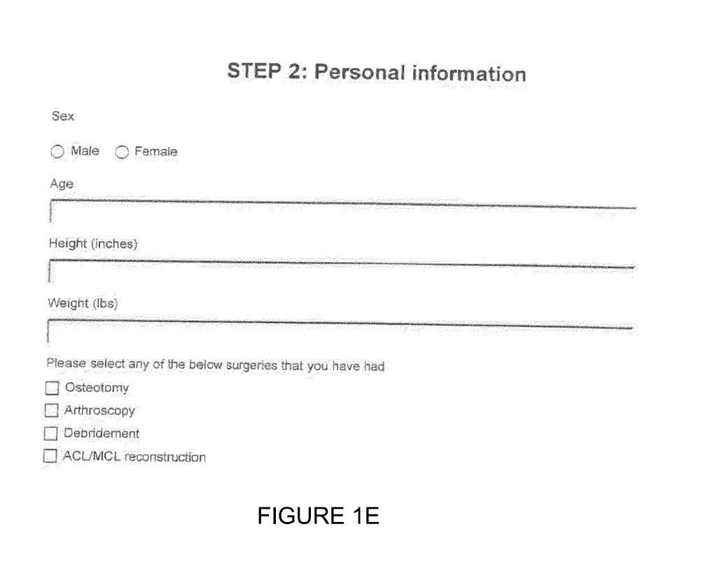

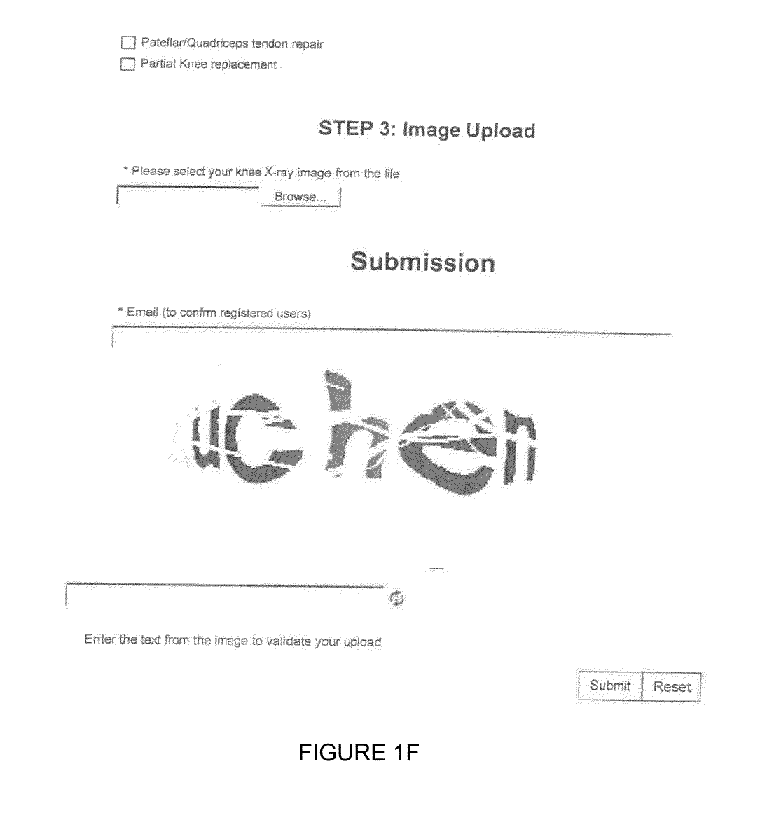

In practice, then, the user logs onto the website, and identifies themselves. A file is opened, and the user is informed that they will complete an evaluation form in three steps. A copy of a relevant portion user interface is FIGS. 1A-1F.

The first step is completion of a disability questionnaire, which asks the user to answer a series of questions based on symptoms, pain, and function, as shown by way of example in FIGS. 1A-1F.

The next step is for the user to input personal metrics including gender, age, height, and weight. The user is also asked to input whatever certain orthopaedic procedures have been carried out on them in the past.

Lastly, the user is asked to upload a radiographic image of the joint in question.

After these steps are complete, the user is required to submit payment or insurance/medical institution information. In this regard, the method of the present invention may, for instance be used by the orthopaedic department of a hospital, and so no payment will actually be required.

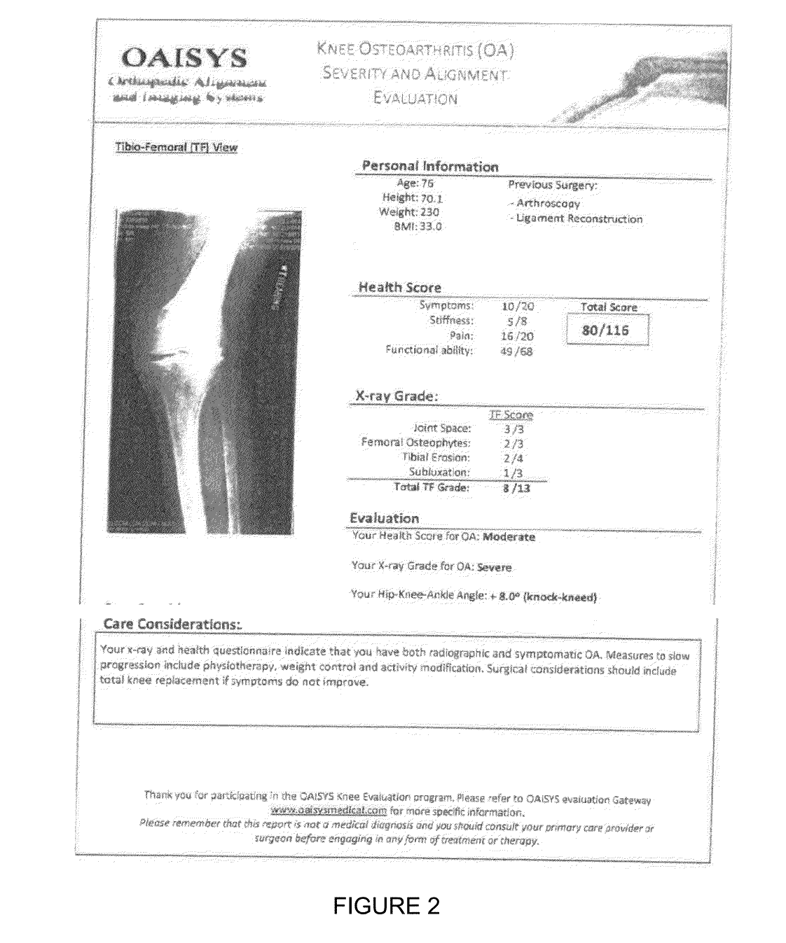

The questionnaire data plus demographics, plus screenings questions to help exclude injury or inflammatory joint disease, and the Knee Images (frontal and the patella-femoral images) are uploaded to the site. These data are tabulated and ranked against data relating to evidenced based clinical studies, the results are formatted as a Patient Specific Report (PSR) an example of which is shown in FIG. 2 including the compilation of the Questionnaire, demographics and Image analysis data. This report, includes all the elements as defined above, and provides a Severity Index of the Arthritic state of the knee at that time. Based on the afore referenced research, these results may correlate with treatment considerations for Joint replacement Surgery. Alternatively, they may indicate considerations for non-surgical care. The resulting report provides a base line of the arthritic status, and, in the situation of a low severity index, may be usefully repeated months or years forwards for evidence of change. In situations of non-surgical considerations, appropriate care with activity modification, physiotherapy, weight control etc. will be indicated, and appropriate referral to specific care providers, such as Physiotherapist and or dietician, indicated.

### ***Creation of the Report

Currently, data on patient demographics, including age, DE and RD are compiled in a Computer based analysis format. The Analysis software, created by OAISYS Inc., is termed Surveyor™. The software format includes the identification of the patient, and the input of their specific data. The program records the values, but applies summation for them automatically to create the Severity Index.

Therapeutic considerations are derived by reference to the evidence based data derived from clinical research.

Thus, for a General Physician (GP), the GP would use the tool to establish the Arthritic severity of a patient presenting with for example historical information of knee pain with an older demographic suggestive of Knee OA. The patient would complete the Disability Questionnaire and obtain a Standing Antero-posterior and a skyline Patello-femoral radiographic views of the knee. The Knee Surgery Triage Web portal at the web site would be engaged and the questionnaire data plus demographics, plus screenings questions to help exclude injury or inflammatory joint disease, and the Knee Images (frontal and the patella-femoral images) are uploaded to the site. These data are analysed using the computer based methods as established by OAISYS Inc, the results are formatted as a Patient Specific Report (PSR) including the compilation of the Questionnaire, demographics and Image analysis data. This report, includes all the elements as defined above, and provides a Severity Index of the Arthritic state of the knee at that time. Based on the afore referenced research, these results may correlate with treatment considerations for Joint replacement Surgery. Alternatively, they may indicate considerations for non-surgical care. The resulting report provides a base line of the arthritic status, and, in the situation of a low severity index, may be usefully repeated months or years forwards for evidence of change. In situations of non-surgical considerations, appropriate care with activity modification, physiotherapy, weight control etc will be indicated, and appropriate referral to specific care providers, such as Physiotherapist and or dietician, indicated.

In the case of an Orthopaedic Surgeon, the information on the KST sent from the GP office will form an evidenced base report on the patient's joint state, with criteria compatible with considerations for surgery. This triage application, will lessen the incidence of inappropriate referrals. The acceptance of this objective evaluation provides substantial assurance for the surgical recommendation, and will, in situations of insurance accountability, significantly improve the success of such claims. If this information did not be part of the referral, the same evaluation is readily available from the surgeon's office. While not described in detail, the specific radiographic gradings of moderate compartmental damage, in conjunction with considerable disability and potentially a younger age will support the consideration of more conservative surgery, including partial joint replacement or realignment surgery.

In the case of individuals with Knee pain and concerns re their potential for OA development, the completion of the KST, appropriately configured in the form of a Web Based Knee Evaluation, provides a means of direct access by the concerned individual to obtain an evidenced based report. This is accomplished by engaging the Web site via a Patient Knee Evaluation Portal, completing the Demographic and questionnaire information on line and uploading the knee images. The outcome, as previously, is the provision of an evidenced base report of the tabulated and ranked data collected, indicating the Arthritis Severity with considerations for care. The opportunity is provided by which the individual may repeat the process months or years forwards to gain an appreciation change; changes that may indicate, for instance, improved levels of disability with minimal evidence of radiographic deterioration, following a program of weight loss, activity modification and appropriate exercises, for instance regular swimming.

The above examples are not intended to restrict the application of the Web Base service for the JST to these applications alone. Other examples of the application of JST are in the Early identification of OA and employment of preventive approaches for groups at risk for OA by nature risk factors (Obesity), family and genetic patterns or occupations (e.g. Infantry, heavy manual labour).

The foregoing embodiments and examples are intended only as examples. No particular embodiment, example, or element of a particular embodiment or example is to be construed as a critical, required, or essential element or feature of any of the claims. Further, no element described herein is required for the practice of the appended claims unless expressly described as “essential” or “critical.” Various alterations, modifications, substitutions, and other variations can be made to the disclosed embodiments without departing from the scope of the present invention, which is defined by the appended claims. The specification, including the figures and examples, is to be regarded in an illustrative manner, rather than a restrictive one, and all such modifications and substitutions are intended to be included within the scope of the invention. Accordingly, the scope of the invention should be determined by the appended claims and their legal equivalents, rather than by the examples given above. For example, steps recited in any of the method or process claims may be executed in any feasible order and are not limited to an order presented in any of the embodiments, the examples, or the claims.

It is not intended that the present method be carried out without the use of a computer. However, it is intended that any refinement, modification or development of the present method enabling it to be carried out without a computer be covered by the claims of this application.

What is claimed is:

1. A computer implemented method of providing remote access to orthopaedic triage services wherein a user is presented, via a computer, with a graphical interface comprising at least one or more of a first graphical interface for input of data comprising personal metrics, a second graphical interface for input of data comprising answers to standardized functional impairment queries, and a third graphical interface for input of prior surgery or injury queries; said user is prompted to upload a radiographic image file to said system; one or more of the personal metrics, functional impairment answers, and prior surgery answers are tabulated, weighted, and combined by a computer to define a preliminary factor; said radiographic image uploaded by said user is subjected to standard analysis to obtain a standardized radiographic score corresponding to the severity of bone or joint damage shown on said radiographic image; the standardized radiographic score being weighted, and combined, by said computer with the preliminary factor to obtain a final score, said final score being compared by said computer with the scores obtained from evidence based clinical studies to obtain a ranking, and the tabulated answers, standardized image analysis, and rankings are forwarded to a clinician or other user in the form of a triage report, whereby a triage decision can be made by a user on the basis of ranking, and available resources.

2. A method is claimed in claim 1, wherein one of said personal metrics is age; and wherein age at or over 60 years has about the same contribution to a calculation of said preliminary factor as prior surgery or injury on a particular joint.

3. A method is claimed in claim 2, wherein the greatest contribution to a calculation of said preliminary factor is the results of the functional impairment queries.

4. A method is claimed in claim 3, wherein the standardized radiographic score has at least as great a contribution to said final score as said preliminary factor.

5. A method as claimed in claim 1, including the further step of inputting payment or insurance information into said computer.

6. A method as claimed in claim 1, wherein said inputs and upload are subject to discriminative analysis and outcome modelling to optimize weighting to be applied to each.
